(19) United States
(12) Patent Application Publication
(10) Pub. No.: US 2026/0360803 A1
(43) Pub. Date: Nov. 12, 2026

(54) LITHIUM SECONDARY BATTERY

(71) Applicant: LOTTE CHEMICAL CORPORATION, Seoul (KR)

(72) Inventors: Jae Yun Park, Seoul (KR); Hyun Jin Jung, Seoul (KR); Sang Sun Park, Seoul (KR); Se Ho Park, Seoul (KR); Young Min Baek, Seoul (KR); Mi Jin Jung, Seoul (KR)

(73) Assignee: LOTTE CHEMICAL CORPORATION, Seoul (KR)

(21) Appl. No.: 19/123,888

(22) PCT Filed: Nov. 13, 2023
(86) PCT No.: PCT/KR2023/018199

§ 371 Date: Apr. 24, 2025

(30) Foreign Application Priority Data
Nov. 30, 2022 (KR) 10-2022-0165239

(51) Int. Cl. H01M 10/056; H01M 10/0525

(52) U.S. Cl. CPC H01M 10/056; H01M 10/0525; H01M 2300/0071; H01M 2300/0091; H01M 2300/0094

(57) ABSTRACT

The present disclosure relates to a lithium secondary battery. According to the present disclosure, the lithium secondary battery has high ionic conductivity and low interfacial resistance, thereby having a long lifespan.

### TECHNICAL FIELD

The present disclosure relates to a lithium secondary battery.

### BACKGROUND ART

Demand for secondary batteries is increasing in various fields, such as PCs, mobile phones, electric vehicles, and energy storage devices. Among secondary batteries, particularly, a lithium secondary battery has a higher capacity density than other secondary batteries and operates even at high voltages.

The lithium secondary battery generally consists of a cathode (reduction electrode); an anode (oxidation electrode); and an electrolyte interposed between the cathode and the anode and containing a lithium salt. The electrolyte includes a non-aqueous liquid electrolyte or a solid electrolyte. The non-aqueous liquid electrolyte penetrates into the inside of the cathode. Therefore, the non-aqueous liquid electrolyte may provide high electrical performance by easily forming an interface between the active material of the cathode and the electrolyte.

However, the non-aqueous liquid electrolyte is vulnerable to ignition due to overcurrent and the like caused by short circuits, etc., by using flammable organic solvents. Therefore, the non-aqueous liquid electrolyte requires the installation of separate safety devices, selection of special battery materials, etc., and limits a battery structural design. This causes increased manufacturing costs and decreased productivity of the lithium secondary battery.

All-solid-state batteries replace liquid electrolytes with solid electrolytes. The all-solid-state batteries have no disadvantage of using flammable organic solvents.

Therefore, the advantages of all-solid-state batteries are low manufacturing costs and excellent productivity. In addition, the all-solid-state batteries have a simple structure. Therefore, the advantages of the all-solid-state battery structure are excellent stability and high capacity and output.

Types of solid electrolytes include a sulfide solid electrolyte, an oxide solid electrolyte, a polymer solid electrolyte, and the like. The sulfide solid electrolyte and the oxide solid electrolyte need to be compressed at high temperature and pressure due to high interfacial resistance. It is advantageous that the polymer solid electrolyte may be manufactured under normal conditions (room temperature and atmospheric pressure).

However, due to the high crystallinity of polymers, the ionic conductivity of the polymer solid electrolyte is lower than that of the non-aqueous liquid electrolyte. In addition, the interfacial resistance between the polymer solid electrolyte and the electrode is high. As the contact area between the polymer solid electrolyte and the electrode increases, the interfacial resistance between the electrode and the electrolyte decreases. Polymer solid electrolytes with low interfacial resistance may exhibit ion mobility equivalent to that of non-aqueous liquid electrolytes, thereby extending the life of the batteries.

### DISCLOSURE

### Technical Problem

An object of the present disclosure is to increase the ionic conductivity of a lithium secondary battery and reduce the interfacial resistance, thereby increasing the lifespan thereof.

### Technical Solution

According to an aspect of the present disclosure, a lithium secondary battery includes a solid electrolyte layer; a cathode layer disposed on one surface of the solid electrolyte layer; and an anode layer disposed on the opposite side of the cathode layer with respect to the solid electrolyte layer. The solid electrolyte layer includes: a first polymer solid electrolyte layer containing a first polymer solid electrolyte, which contains a polymer component, a plasticizer, and a lithium salt, and an inorganic filler; and a second polymer solid electrolyte layer containing a second polymer solid electrolyte, which contains a polymer component, a plasticizer, and a lithium salt, but not containing an inorganic filler. The first polymer solid electrolyte layer includes first and second surfaces having different surface roughness in a thickness direction. The surface roughness of the first surface is higher than the surface roughness of the second surface. The first surface is disposed on the side of the second polymer solid electrolyte layer. The inorganic filler is barium titanate.

### Advantageous Effects

According to the present disclosure, the lithium secondary battery has high ionic conductivity and low interfacial resistance, thereby having a long lifespan.

### DESCRIPTION OF DRAWINGS

FIGS. 1 and 2 show a progress process of Example.

FIG. 3 shows capacity retention rates of Example 1 and Comparative Example 1.

FIG. 4 shows impedances of Example 2 and Comparative Example 2.

### MODES

The present disclosure relates to a lithium secondary battery.

The lithium secondary battery of the present disclosure includes a solid electrolyte layer, a cathode layer, and an anode layer. The cathode layer is disposed on one surface of the solid electrolyte layer, and the anode layer is disposed on the opposite side of the cathode layer with respect to the solid electrolyte layer. That is, the cathode layer, the solid electrolyte layer, and the anode layer are disposed in the above order or in reverse order.

The solid electrolyte layer has a specific structure. The solid electrolyte layer includes a plurality of independent polymer solid electrolyte layers. The solid electrolyte layer includes at least two polymer solid electrolyte layers, that is, a first polymer solid electrolyte layer and a second polymer solid electrolyte layer.

The first polymer solid electrolyte layer and the second polymer solid electrolyte layer have compositions of the polymer solid electrolyte. The first polymer solid electrolyte layer and the second polymer solid electrolyte layer contain a polymer component, a plasticizer, and a lithium salt, respectively.

In one specific embodiment, the components included in the first polymer solid electrolyte layer and the components included in the second polymer solid electrolyte layer may be the same as or different from each other.

In one specific embodiment, the first polymer solid electrolyte layer and the second polymer solid electrolyte layer may be adjacent to each other. In this case, there may be no separate layer between the first polymer solid electrolyte layer and the second polymer solid electrolyte layer.

In one specific embodiment, there may be a separate layer between the first polymer solid electrolyte layer and the second polymer solid electrolyte layer.

The first polymer solid electrolyte layer and the second polymer solid electrolyte layer differ according to whether or not to contain an inorganic filler.

The first polymer solid electrolyte layer contains an inorganic filler. The second polymer solid electrolyte layer does not contain an inorganic filler.

In this specification, the fact that a configuration does not include a specific configuration means that other configurations other than the specific configuration may be present in the configuration.

The inorganic filler is barium titanate (BaTiO₃). Since the barium titanate is a highly dielectric material, the barium titanate is introduced to significantly improve ionic conductivity compared to other inorganic materials (e.g., Al₂O₃).

Barium titanate having a particle size of 100 nm or less may be used as the inorganic filler.

The smaller the particle size of the inorganic filler, the higher the surface area, so that it is advantageous to use smaller particles.

When only the polymer solid electrolyte layer containing one inorganic filler is positioned between the cathode and the anode, the contact area between the polymer solid electrolyte layer and the electrode is reduced. This is because the surface roughness of the polymer solid electrolyte layer is increased when the inorganic filler is introduced into the polymer solid electrolyte layer. Here, the increased surface roughness of the polymer solid electrolyte layer should be reduced by introducing a layer that does not contain an inorganic filler, like the second polymer electrolyte layer.

The first polymer solid electrolyte layer includes first and second surfaces having different surface roughness in a thickness direction by containing the inorganic filler. Here, the surface roughness of the first surface is higher than the surface roughness of the second surface. By introducing a polymer electrolyte layer without an inorganic filler onto a surface with high surface roughness and a surface with a low surface roughness adjacent to the electrode, a problem of a reduction in the electrode contact area due to the introduction of an inorganic filler may be reduced. That is, the first surface is disposed on the side of the second polymer solid electrolyte layer. That is, the lithium ion battery of the present disclosure has a laminated structure of a cathode layer (anode layer)/a second surface of a first polymer electrolyte layer/a first surface of the first polymer electrolyte layer/a second polymer electrolyte layer/an anode layer (cathode layer).

In one specific embodiment, the first polymer solid electrolyte layer may be adjacent to the anode layer. The first polymer solid electrolyte layer may be disposed on the side of the anode layer. The first polymer solid electrolyte layer may be closer to the anode layer than the second solid electrolyte layer.

In one specific embodiment, the second polymer solid electrolyte layer may be adjacent to the cathode layer. The second polymer solid electrolyte layer may be disposed on the side of the cathode layer. The second polymer solid electrolyte layer may be closer to the cathode layer than the first solid electrolyte layer.

In one specific embodiment, a specific material may be used as an active material of the cathode layer. Specifically, the cathode layer may include a compound represented by the following Chemical Formula 1:

LiNiₐCo_{b}Mn_{c}O₂ (0.6≤a≤0.9, a+b+c=1). [Chemical Formula 1]

Preferably, in Chemical Formula 1 above, a may be close to 0.8, and b and c may each be close to 0.1. More preferably, the cathode layer may include a material known as NCM811.

In one specific embodiment, the lithium secondary battery of the present disclosure may be a lithium metal battery. The lithium metal battery uses a lithium metal as the anode. That is, in one specific embodiment, the anode layer may include a lithium metal.

The type of polymer component is not particularly limited, and may be appropriately selected. The polymer component may be selected from, for example, polyethylene oxide (PEO), polyvinylchloride (PVC), poly(methyl methacrylate) (PMMA), polyacrylonitrile (PAN), poly(vinylidene fluoride) (PVDF), poly(vinylidene fluoride-hexafluoropropylene) (PVDF-HFP), etc. Preferably, the polymer component may be PAN. In one specific embodiment, in each of the first polymer solid electrolyte layer and the second polymer solid electrolyte layer, the polymer component may be polyacrylonitrile.

The content of the polymer component is not particularly limited, and may be appropriately adjusted within a range in which the present disclosure may at least exhibit the function of the polymer electrolyte due to appropriate softness and liquid content. In one specific embodiment, in each of the first polymer solid electrolyte layer and the second polymer solid electrolyte layer, the content of the polymer component may be in the range of 18 wt % to 21 wt %.

The plasticizer reduces the crystallinity of the polymer components in the polymer solid electrolyte, thereby increasing an amorphous region. The plasticizer may be a nitrile-based compound selected from glutanonitrile, succinonitrile, acetonitrile, adiponitrile, methoxyacetonitrile, and the like. Preferably, the plasticizer is glutanonitrile. In one specific embodiment, in each of the first polymer solid electrolyte layer and the second polymer solid electrolyte layer, the plasticizer may be glutanonitrile.

The content of the plasticizer is not particularly limited and may be appropriately adjusted within the range in which the performance of the present disclosure is exhibited. In one specific embodiment, in each of the first polymer solid electrolyte layer and the second polymer solid electrolyte layer, the content of the plasticizer may be in the range of 0.7 mol to 1.0 mol with respect to 1 mol of the polymer component.

The content of the inorganic filler in the first polymer electrolyte layer is not particularly limited and may be appropriately adjusted within the range in which the performance of the present disclosure is exhibited. In one specific embodiment, the content of the inorganic filler may be in the range of 50 parts by weight to 100 parts by weight with respect to 100 parts by weight of the polymer component. If the content of the inorganic filler is within the range, the first polymer electrolyte layer may have a form in which the polymer is dispersed in the inorganic filler. That is, within the content range of the inorganic filler, the dispersibility of the inorganic filler does not need to be considered.

In one specific embodiment, the thicknesses of the first polymer solid electrolyte layer and the second polymer solid electrolyte layer may be controlled to obtain a lithium secondary battery exhibiting appropriate ion conductivity and structural stability.

In one specific embodiment, a thickness ratio (T1/T2) of the first polymer solid electrolyte layer (T1) and the second polymer solid electrolyte layer (T2) may be within the range of 0.5 to 2. The lower limit of the range may be 0.6, 0.7, 0.8, 0.9, or 1.0. The upper limit of the range may be 1.9, 1.8, 1.7, 1.6, 1.5, 1.4, 1.3, 1.2, 1.1, or 1.0.

In one specific embodiment, the thickness of each of the first polymer solid electrolyte layer and the second polymer solid electrolyte layer may also be controlled. The thicknesses of the first polymer solid electrolyte layer and the second polymer solid electrolyte layer may be in the range of 30 μm to 50 μm, respectively.

Hereinafter, the present disclosure will be described in more detail by Examples. However, the scope of the present disclosure is not limited to the following Examples.

### [Materials]

In Table 1, the types and sources of materials used in Examples and Comparative Examples were summarized.

TABLE 1

| | | | Composition | |
|---|---|---|---|---|
| Classification | Material | Manufacturer | ratio (wt %) | Note |
| Polymer | Polyacrylonitrile | Sigma Aldrich | 6 | Mw 150,000 |
| component | | | | |
| Solvent | Ethylene Carbonate | Sigma Aldrich | 69 | B.P. 243 °C |
| Lithium salt | LiPF₆ | Wellcos | 6 | Purity 99.9% |
| Plasticizer | Glutaronitrile | Sigma Aldrich | 19 | B.P. 287 °C |
| Inorganic filler | Barium Titanate | Sigma Aldrich | — | <100 nm |
| | | | | nano powder |

### [Comparative Example 1] Polymer Solid Electrolyte

A polymer component was uniformly mixed and dissolved in a solvent at 80 °C for 2 hours. Next, 0.74 M of a lithium salt was added therein and mixed for 1 hour. Next, PAN:GN was added therein at a molar ratio of 1:1.8 and mixed at 70 °C for 30 minutes to prepare a polymer solid electrolyte solution. The solution was cast on a glass plate to a size of 30 μm and then vacuum-dried at 90 °C for 50 minutes to prepare a polymer solid electrolyte. The content of the solvent remaining in the polymer solid electrolyte was 50 wt %.

### [Comparative Example 2] Polymer Solid Electrolyte

A polymer component was uniformly mixed and dissolved in a solvent at 80 °C for 2 hours. Next, 0.74 M of a lithium salt was added therein and mixed for 1 hour. Next, PAN:GN was added therein at a molar ratio of 1:1.8 and mixed at 70 °C for 30 minutes. Next, 50 parts by weight of an inorganic filler was further added therein with respect to 100 parts by weight of the polymer component and then mixed using a Thinky mixer to prepare a polymer solid electrolyte solution. The solution was cast on a glass plate to a size of 30 μm and then vacuum-dried at 90 °C for 50 minutes to prepare a polymer solid electrolyte. The content of the solvent remaining in the polymer solid electrolyte was 50 wt %.

### [Comparative Example 3] Polymer Solid Electrolyte

The same process as Comparative Example 2 was repeated, except that the content of the inorganic filler was changed to 75 parts by weight with respect to 100 parts by weight of the polymer component.

### [Comparative Example 4] Polymer Solid Electrolyte

The same process as Comparative Example 2 was repeated, except that the content of the inorganic filler was changed to 100 parts by weight with respect to 100 parts by weight of the polymer component.

### [Example 1] Polymer Solid Electrolyte

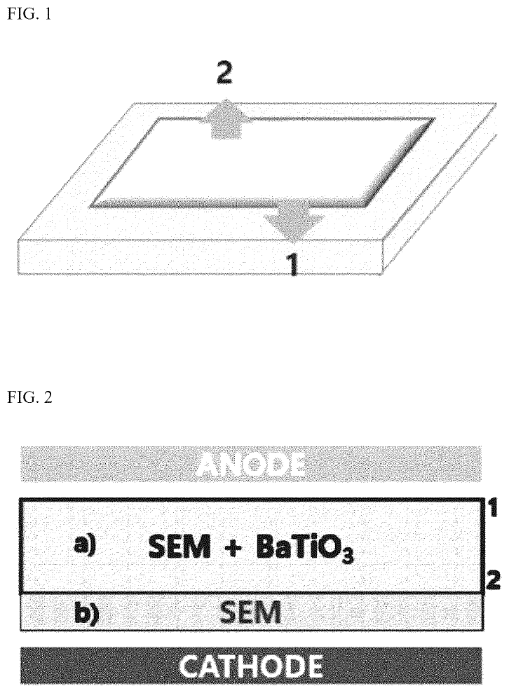

Example 1 was described with reference to FIGS. 1 and 2.

A first polymer solid electrolyte layer having a thickness of 200 μm was prepared on a glass substrate using the polymer solid electrolyte solution of Comparative Example 2. Here, the roughness of the surface (1 of FIGS. 1 and 2) of the first polymer solid electrolyte layer in contact with the glass substrate was lower than the roughness of the opposite surface (2 of FIGS. 1 and 2) of the first polymer solid electrolyte layer.

A second polymer solid electrolyte layer having a thickness of 100 μm was prepared using the polymer solid electrolyte solution of Comparative Example 1. The second polymer solid electrolyte layer was laminated on the opposite surface (2 of FIGS. 1 and 2) of the surface (1 of FIGS. 1 and 2) of the first polymer solid electrolyte layer in contact with the glass without separate pressure application to prepare one polymer solid electrolyte layer having a thickness of 300 μm.

### Example 2

The same process as Example 1 was repeated, except that the polymer solid electrolyte solution of Comparative Example 3 was used instead of the polymer solid electrolyte solution of Comparative Example 2.

### Example 3

The same process as Example 1 was repeated, except that the polymer solid electrolyte solution of Comparative Example 4 was used instead of the polymer solid electrolyte solution of Comparative Example 2.

### [Experimental Example 1] Evaluation of Ionic Conductivity

The polymer electrolyte layers of Examples and Comparative Examples were positioned between lithium metals. A coin cell was assembled by laminating lithium metal/polymer solid electrolyte layer/lithium metal in sequence. The internal resistance of the coin cell was measured to evaluate the ionic conductivity of the polymer solid electrolyte. The diameter of each lithium metal electrode was 16 mmΦ. MP1 from Wonatech was used as measuring equipment. The measurement conditions were room temperature and a frequency range of 1 Hz to 1 MHz.

### [Experimental Example 2] Evaluation of Capacity Retention Rate

The polymer electrolyte layers of Examples and Comparative Examples were positioned between NCM811 (cathode) and lithium metal (anode). A coin cell was assembled by laminating NCM811/polymer solid electrolyte layer/lithium metal in sequence. The diameter of each electrode was 16 mmΦ. The charge/discharge capacity of the coin cell was measured to evaluate a capacity retention rate. Charging/discharging was performed with 0.3 C, and the voltage range was 3.0 V to 4.3 V. The battery lifespan was calculated through a discharge retention rate. Specifically, the number of charge/discharge cycles at which the discharge amount became 80% of an initial battery discharge amount was defined as the battery lifespan.

### [Experimental Example 3] Evaluation of Cell Resistance

The impedance of the coin cell manufactured in Experimental Example 2 was measured to evaluate a cell resistance. MP1 from Wonatech was used as measuring equipment. The measurement conditions were room temperature and a frequency range of 1 Hz to 1 MHz. At room temperature, the coin cell was aged for approximately 30 minutes after assembly of the coin cell, and then the measurements were performed, so that the polymer solid electrolyte layer was well bonded between the electrodes.

### Results and Discussion

Table 2 shows compositions of components used in Comparative Examples and results of evaluating the ionic conductivity of Comparative Examples.

Table 3 shows compositions of components used in Examples and results of evaluating the ionic conductivity of Examples.

TABLE 2

| | | Com. Ex. 1 | | Com. Ex. 2 | | Com. Ex. 3 | | Com. Ex. 4 | |
|---|---|---|---|---|---|---|---|---|---|
| | | | Added | | Added | | Added | | Added |
| | | Content | amount | Content | amount | Content | amount | Content | amount |
| Classification | Material | [%] | [g] | [%] | [g] | [%] | [g] | [%] | [g] |
| First | Polymer | 5.7 | 0.4 | 5.7 | 0.4 | 5.6 | 0.4 | 5.6 | 0.4 |
| polymer | component | | | | | | | | |
| solid | Solvent | 67.1 | 4.7 | 67.1 | 4.7 | 66.1 | 4.7 | 65.3 | 4.7 |
| electrolyte | Lithium | 5.7 | 0.4 | 5.7 | 0.4 | 5.6 | 0.4 | 5.6 | 0.4 |
| layer | salt | | | | | | | | |
| | Plasticizer | 18.6 | 1.3 | 18.6 | 1.3 | 18.3 | 1.3 | 18.1 | 1.3 |
| | Inorganic | 0 | 0 | 2.9 | 0.2 | 4.2 | 0.3 | 5.6 | 0.4 |
| | filler | | | | | | | | |
| Second | Polymer | — | — | — | — | — | — | — | — |
| polymer | component | | | | | | | | |
| solid | Solvent | — | — | — | — | — | — | — | — |
| electrolyte | Lithium | — | — | — | — | — | — | — | — |
| layer | salt | | | | | | | | |
| | Plasticizer | — | — | — | — | — | — | — | — |

| | | Ionic | | Ionic | | Ionic | | Ionic |
|---|---|---|---|---|---|---|---|---|
| | Thickness | conductivity | Thickness | conductivity | Thickness | conductivity | Thickness | conductivity |
| | [μm] | [mS/cm] | [μm] | [mS/cm] | [μm] | [mS/cm] | [μm] | [mS/cm] |
| Polymer solid | 260 | 1.27 | 310 | 1.22 | 300 | 1.10 | 290 | 0.49 |
| electrolyte layer | | | | | | | | |

TABLE 3

| | | Com. Ex, 1 | | Com. Ex. 2 | | Com. Ex. 3 | |
|---|---|---|---|---|---|---|---|
| | | | Added | | Added | | Added |
| | | Content | amount | Content | amount | Content | amount |
| Classification | Material | [%] | [g] | [%] | [g] | [%] | [g] |
| First polymer | Polymer component | 5.7 | 0.4 | 5.7 | 0.4 | 5.6 | 0.4 |
| solid electrolyte | Solvent | 67.1 | 4.7 | 67.1 | 4.7 | 65.3 | 4.7 |
| layer | Lithium salt | 5.7 | 0.4 | 5.7 | 0.4 | 5.6 | 0.4 |
| | Plasticizer | 18.6 | 1.3 | 18.6 | 1.3 | 18.1 | 1.3 |
| | Inorganic filler | 2.9 | 0.2 | 4.2 | 0.3 | 5.6 | 0.4 |
| Second polymer | Polymer component | 5.7 | 0.4 | 5.7 | 0.4 | 5.7 | 0.4 |
| solid electrolyte | Solvent | 67.1 | 4.7 | 67.1 | 4.7 | 67.1 | 4.7 |
| layer | Lithium salt | 5.7 | 0.4 | 5.7 | 0.4 | 5.7 | 0.4 |
| | Plasticizer | 18.6 | 1.3 | 18.6 | 1.3 | 18.6 | 1.3 |

| | | Ionic | | Ionic | | Ionic |
|---|---|---|---|---|---|---|
| | Thickness | conductivity | Thickness | conductivity | Thickness | conductivity |
| | [μm] | [mS/cm] | [μm] | [mS/cm] | [μm] | [mS/cm] |
| Polymer solid | 300 | 2.54 | 300 | 2.20 | 300 | 3.30 |
| electrolyte layer | | | | | | |

In Comparative Examples 1 to 3, it was shown that when an inorganic filler was introduced into a single polymer electrolyte layer, the ionic conductivity was not increased or rather decreased. In Examples 1 and 2, it was shown that when a polymer electrolyte layer without an inorganic filler introduced was laminated on a single polymer electrolyte layer with an inorganic filler introduced, an effect of increasing ionic conductivity due to the introduction of the inorganic filler may be clearly exhibited.

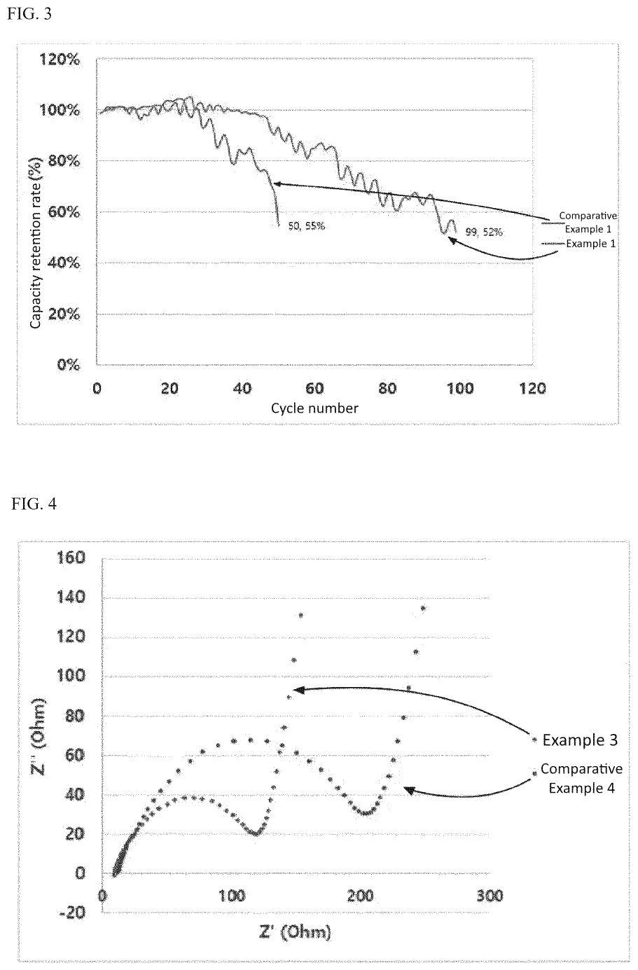

FIG. 3 shows capacity retention rates of Example 1 and Comparative Example 1. Through FIG. 3, it may be confirmed that in Comparative Example 1, the capacity drops to 60% within 50 cycles after performing charge/discharge. In addition, through FIG. 3, it may be confirmed that in Example 1, the number of cycles in which the capacity drops to 60% has increased to 100 cycles. Through this, it may be confirmed that when the polymer electrolyte layer without the inorganic filler introduced is laminated on the single polymer electrolyte layer with the inorganic filler introduced, the capacity retention rate of the battery is also improved due to a decrease in the interfacial resistance between the electrolyte layer and the electrode.

FIG. 4 shows impedances of Example 2 and Comparative Example 2. The resistance of the electrolyte is represented by a semicircular shape in the graph, and the larger the diameter, the greater the resistance. Through this, it may be confirmed that the interfacial resistance of the battery is reduced when the polymer electrolyte layer without the inorganic filler introduced is laminated on the single polymer electrolyte layer with the inorganic filler introduced.

1. A lithium secondary battery comprising:
a solid electrolyte layer;
a cathode layer disposed on one surface of the solid electrolyte layer; and
an anode layer disposed on the opposite side of the cathode layer with respect to the solid electrolyte layer,
wherein the solid electrolyte layer comprises
a first polymer solid electrolyte layer containing a first polymer solid electrolyte, which contains a polymer component, a plasticizer, and a lithium salt, and an inorganic filler; and
a second polymer solid electrolyte layer containing a second polymer solid electrolyte, which contains a polymer component, a plasticizer, and a lithium salt, but not containing an inorganic filler,
wherein the first polymer solid electrolyte layer includes first and second surfaces having different surface roughnesses in a thickness direction,
the surface roughness of the first surface is higher than the surface roughness of the second surface,
the first surface is disposed on the side of the second polymer electrolyte layer, and
the inorganic filler is barium titanate.

2. The lithium secondary battery of claim 1, wherein the first polymer solid electrolyte layer is disposed on the side of the anode layer, and
the second polymer solid electrolyte layer is disposed on the side of the cathode layer.

3. The lithium secondary battery of claim 1, wherein the cathode layer comprises a compound represented by the following Chemical Formula 1:
LiNiₐCo_{b}Mn_{c}O₂ (0.6≤a≤0.9, a+b+c=1). [Chemical Formula 1]

4. The lithium secondary battery of claim 1, wherein the anode layer contains a lithium metal.

5. The lithium secondary battery of claim 1, wherein in each of the first polymer solid electrolyte layer and the second polymer solid electrolyte layer, the polymer component is polyacrylonitrile.

6. The lithium secondary battery of claim 1, wherein in each of the first polymer solid electrolyte layer and the second polymer solid electrolyte layer, the content of the polymer component is in the range of 18 wt % to 21 wt %.

7. The lithium secondary battery of claim 1, wherein in each of the first polymer solid electrolyte layer and the second polymer solid electrolyte layer, the plasticizer is glutanonitrile.

8. The lithium secondary battery of claim 1, wherein in each of the first polymer solid electrolyte layer and the second polymer solid electrolyte layer, the content of the plasticizer is in the range of 0.7 mol to 1.0 mol with respect to 1 mol of the polymer component.

9. The lithium secondary battery of claim 1, wherein the content of the inorganic filler is in the range of 50 parts by weight to 100 parts by weight with respect to 100 parts by weight of the polymer component.

10. The lithium secondary battery of claim 1, wherein the thicknesses of the first polymer solid electrolyte layer and the second polymer solid electrolyte layer are in the range of 30 μm to 50 μm, respectively.

11. The lithium secondary battery of claim 1, wherein a thickness ratio (T1/T2) of the first polymer solid electrolyte layer (T1) and the second polymer solid electrolyte layer (T2) is in the range of 0.5 to 2.
